(19) United States
(12) Patent Application Publication
(10) Pub. No.: US 2016/0299898 A1
(43) Pub. Date: Oct. 13, 2016

(54) APPARATUSES, METHODS, AND SYSTEMS FOR RANKING AND COMPARING USER-GENERATED POSTS

(71) Applicant: WonUpIt, Atlanta, GA (US)

(72) Inventors: Ross Edward Lucier, Atlanta, GA (US); Tanveer Singh Chandok, Hoboken, NJ (US)

(21) Appl. No.: 15/096,137

(22) Filed: Apr. 11, 2016

Related U.S. Application Data
(60) Provisional application No. 62/145,169, filed on Apr. 9, 2015.

(51) Int. Cl. G06F 17/30; G06Q 30/02

(52) U.S. Cl. CPC G06F 17/3053; G06F 17/30864; G06Q 30/0277

(57) ABSTRACT

Apparatuses, methods, and systems for ranking and comparing user-generated posts can provide a platform on which users can upload photos and/or videos (“media”). Other users can then post different media believed to be superior to the original media upload. Other users can award trophies to all of the media, and media receiving greater numbers of trophies may receive relatively higher rankings.

### CROSS-REFERENCE TO RELATED APPLICATIONS

This application claims priority to, and the benefit of, U.S. Provisional Application No. 62/145,169, entitled APPARATUSES, METHODS, AND SYSTEMS FOR RANKING AND COMPARING USER-GENERATED POSTS, filed Apr. 9, 2015, which is incorporated by reference herein in its entirety for all purposes.

### BACKGROUND

The Internet allows for many types of communication, which has led to the development of social networks. Various types of social networks exist, connecting people with similar backgrounds, careers, interests, and the like.

### SUMMARY

Various embodiments of the Apparatuses, Methods and Systems for Ranking and Comparing User-Generated Posts (“RCUGP”) described herein allow users to upload content, such as photos, videos, or other media, to a server. Users can award the content with trophies, comment, and share the content. In some implementations, users can vote for their favorite content. Additional embodiments allow other users to upload new content, such as their own photos or videos, that the users believe is superior to the originally uploaded content. Other users can award the new content with trophies, which indicates that they agree that the new content is superior to the original content. Alternatively, users may continue awarding trophies to the original content, thereby indicating a preference for the original content relative to the newer content.

In some embodiments, when a user uploads a new photo or video, the user can challenge others to find or develop and upload superior content. In some embodiments, the users can challenge specific users, such as friends, to post superior content, and in other implementations, users can challenge everyone to beat their photo or video by posting superior content. Some embodiments allow users to choose whether to challenge everyone or just specific users. Users can set parameters for other users to use to find their uploaded content.

In one aspect the disclosure pertains to a system and method for facilitating media-based challenges. The method includes receiving, at a server, an initial media upload associated with an account of a challenger and information identifying one or more challenged users. The initial media upload may be provided by a client application executing on a user device of the challenger. A database of users may then be searched to determine if there exists an account corresponding to the at least one challenged user. A challenge notification for the account corresponding to the challenged user may be generating at the server. The method further includes receiving, at the server and in response to the challenge notification, a response media upload associated with the account corresponding to the challenged user. A response notification for the account of the challenger may then be generated and provided to the client application.

In the case in which it is determined that there does not exist an account corresponding to the at least one challenged user, a corresponding indication may be provided to the account of the challenger. To the extent the challenger desires to send an invitation the at least one challenged user, a corresponding indicator from the client application is received. A message used in sending the invitation to the at least one challenged user may then be generated.

The media upload may be associated with a category and, in this case, the response media upload may be automatically associated with the same category.

In a particular embodiment additional response media uploads associated with accounts corresponding to other challenged users are also received by the server. A thread may be formed in order to associate each of the additional response media uploads with the initial media upload. In response, trophy indicators may be received from a plurality of other users. Each of the trophy indicators may be associated with one of the media uploads.

The disclosure also relates to a processor-implemented method which includes receiving, at a server, information identifying a sponsored category associated with a sponsoring company. The method includes generating a thread associated with the sponsored category and the sponsoring company. At least one media upload from at least one user may be received at the server. The media upload is associated with the sponsored category and is provided by a client application executing on a user device. The server may then generate commands resulting in, or otherwise cause, display of the at least one media upload within the thread.

In one implementation the server receives other media uploads from other users. Each of the other media uploads is associated with the sponsored category. The server may also receive a plurality of trophy indicators, each of the plurality of trophy indicators being associated with one of the media uploads. The media uploads may also be sorted based on associated numbers of the plurality of trophy indicators.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates details of a system on which embodiments of the methods described herein may be implemented.

FIG. 2 illustrates details of an embodiment of an example client application for use on a user device.

FIG. 3 illustrates details of an example server system for use with a client application such as shown in FIG. 2.

FIG. 4 is an exemplary data flow diagram for the RCUGP.

FIGS. 5A-G are a series of screenshots illustrating an embodiment of a log-in procedure.

FIG. 6 is a screenshot of an embodiment of a home screen.

FIG. 7 is a screenshot of an embodiment of a user profile.

FIG. 8 is a screenshot of an embodiment showing details of a post.

FIGS. 9A-H are a series of screenshots illustrating an embodiment of creating a post.

FIG. 10 is a screenshot of an embodiment showing a user's private posts.

FIG. 11 is a screenshot of an embodiment showing a contacts list.

FIG. 12 is a screenshot of an embodiment of an explore-popular tab.

FIG. 13 is a screenshot of an embodiment of an explore-users tab.

FIG. 14 is a screenshot of an embodiment of an explore-hashtags tab.

FIG. 15 is a screenshot of an embodiment of an explore-sponsored tab.

### DETAILED DESCRIPTION

In some embodiments, users can upload content, such as photos, videos and/or other media, to the RCUGP. Other users can view the uploaded content and award the photos, videos, and/or other media, with trophies, comment, and share the content. The other users can also upload new photos, videos, and/or other media that the other users think will earn more trophies (“WonUp”) the originally uploaded photo, video, and/or other media. Regardless of who uploads the photo(s), video(s), and/or other media, this may be referred to herein as “content,” “media,” “media post,” or “media upload.” Additional users can then award trophies to either the original or the new media post. The media can be ranked based on the number of trophies awarded, and the RCUGP can display who the leader is for a given category of content.

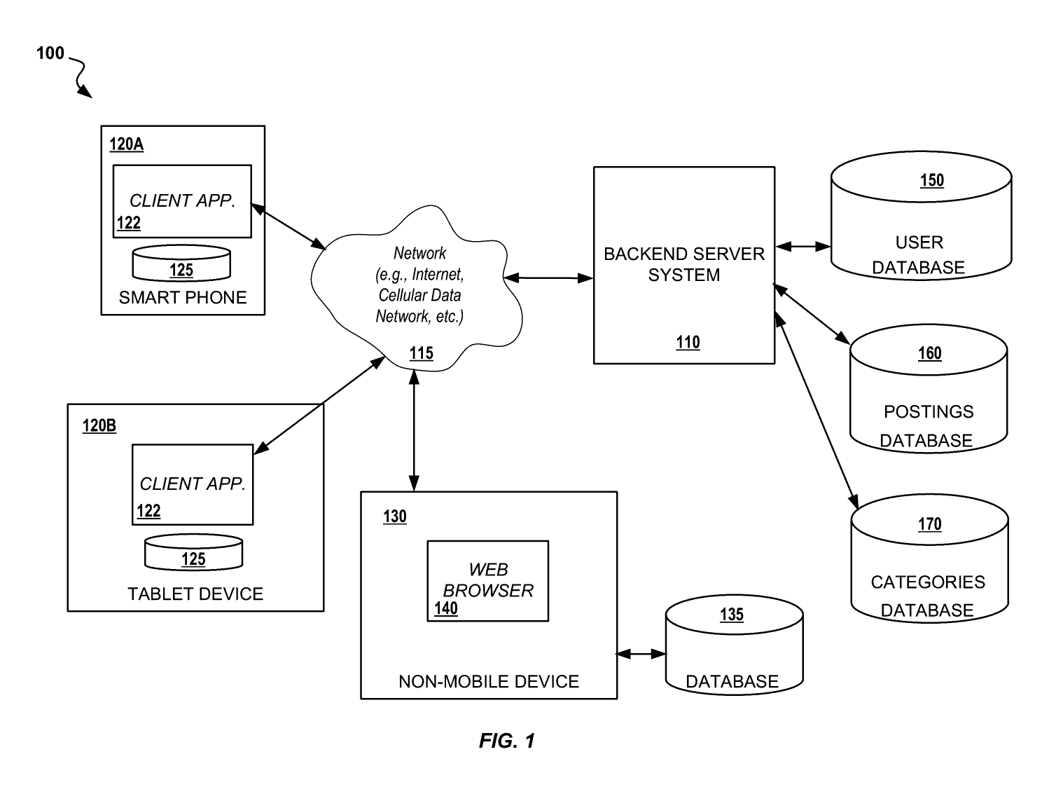

Before further describing various aspects and functionality of the methods described herein, the general context and systems and devices on which embodiments may be implemented are shown in FIGS. 1-4.

For example, FIG. 1 illustrates details of a system 100 on which various embodiments may be implemented. System 100 includes one or more (typically many) mobile user devices 120, which may be netbooks, smart phones, personal digital assistants (PDAs), tablets, or other similar or equivalent mobile devices. As shown in FIG. 1, user device 120A is a smart phone and user device 120B is a tablet device, each of which includes a client application 122, which may be a customized application configured to utilize an operating system of the smart phone 120A or the tablet device 120B. The client application 122 enables the smart phone 120A or the tablet device 120B to gain access to a central server system such as backend server system 110. In addition to mobile user devices 120, the system 100 includes non-mobile devices 130. Such non-mobile devices 130 may include desktop or notebook computers, for example. Non-mobile user device 130 uses a standardized web browser application 140, such as the Internet Explorer, Firefox, or Chrome browsers. Each of user devices 120A, 120B and non-mobile device 130 may communicate with the server system 110 via connections with a network 115, such as the Internet and/or another network such as a cellular data network, to server system 110.

Server system 110 may include or be connected to one or more databases. The exemplary system 100 includes a user database 150, a postings database 160 and a categories database 170. The user database 150 stores information regarding individual users of the system 100. The user information can include information such as a user's name, username, password, friends, categories viewed, categories the user used with posts, content preferences, other users with whom the user has communicated, and/or the like. The postings database 160 stores information regarding postings made on the system 100. The postings database can include information such as the media posted, categories used for each posting, the user who uploaded the posting, the group with whom the user shared the posting (such as all users, all friends, or specific users), number of trophies awarded to each posting, and/or the like. The categories database 170 stores information representing the categories used for postings, and includes information such as posts using a category, trophies awarded for posts within the category, users who post using the category, and/or the like.

Server system 110 will generally include other data storage devices as well as associated hardware, software, memory, peripheral interface devices, and the like, including modules to receive and store data and information, and receive and process input from user devices and associated browsers or client applications.

At user devices 120A and 120B, the client application program 122 may be downloaded and stored on the user device 120 to allow customized access to data and information on the server system 110. The client application program 122 is stored in memory 125. The memory 125 can also store user information and media posted by the user. Alternately, or in addition, the standardized browser application 140 (as shown in non-mobile user device 130) may be provided to allow standardized web access and associated functionality in some implementations. User information and media posted by the user are stored in a database 135 coupled to or included in the non-mobile device 130.

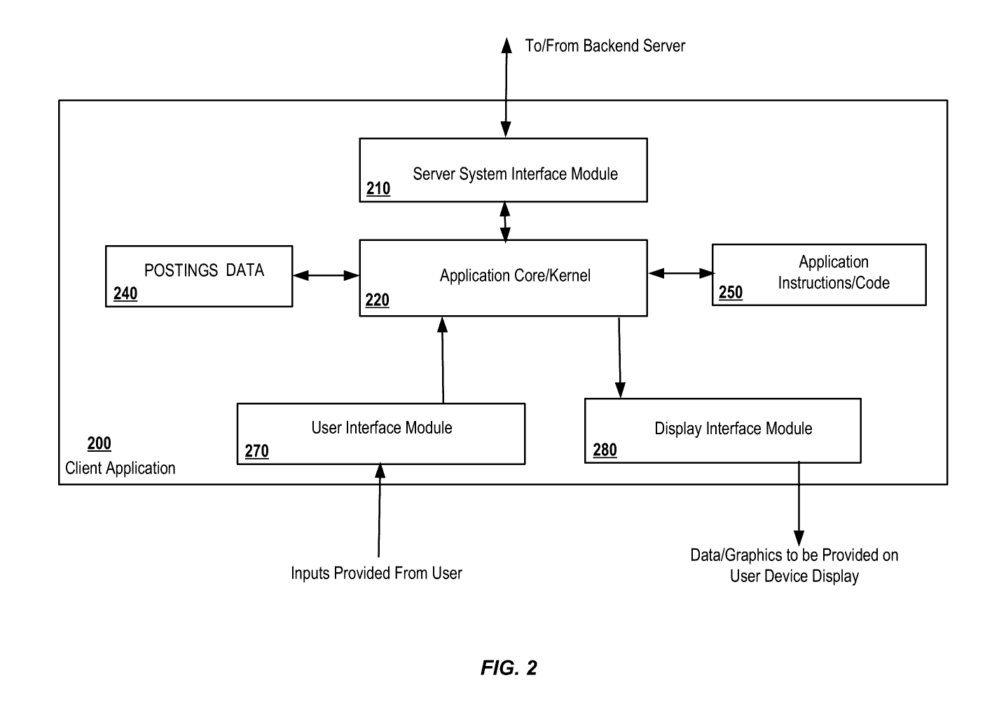

FIG. 2 illustrates details of an embodiment of a client application 200 and associated functional modules. Client application 200 may correspond with the client application 122 as shown in FIG. 1. Client application 200 may include a server system interface module 210 configured to provide an interface or data interchange with an associated server system, such as a server system 110 of FIG. 1. This interface functionality may be provided in conjunction with other software and/or hardware modules in the particular user device, such as operating system functions, wired or wireless interface hardware and software, and the like. Application 200 may also include an application core or kernel module 220 configured to perform the basic functionality described subsequently with respect to client application 122 and/or user device operation. In particular, this functionality may be as illustrated in the figures and described subsequently herein. Client application 200 may further include a postings data module 240 to store data associated with the client application, such as media posted by the user, data being processed by the application core 220, data received from the server system 110, and/or other data or information. In addition, client application 200 may include application instructions or computer code in a code or instruction module 250. The code or instruction module 250 may include a specific series of instructions and steps to perform the functions described subsequently herein. The computer code or instructions may be stored on a non-transitory computer readable medium configured to provide instructions to a processor or other similar or analogous device, such as a programmable logic device, DSP, etc.

Client application module 200 may further include a user interface module 270 configured to receive input from a user, such as user selections, search data or information, or other information provided from a user. In addition, the client application module 200 may include a display interface module 280 configured to provide output information to a display (not shown) of a client device, such as an LCD or other display screen.

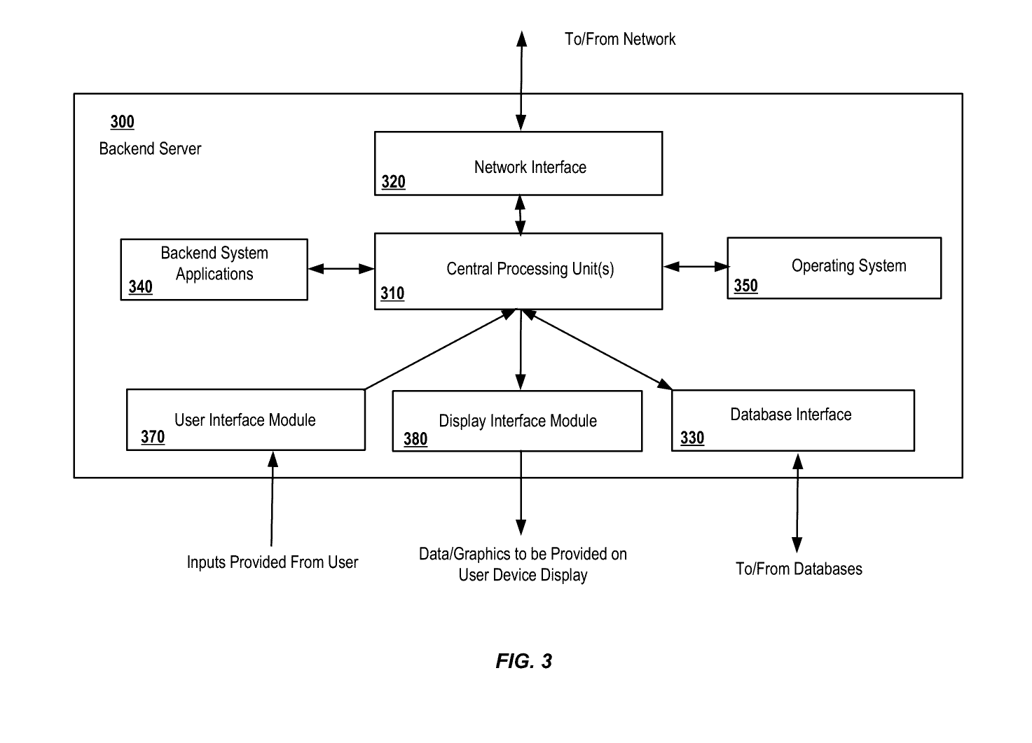

FIG. 3 illustrates one embodiment of details of aspects of a server system 300, which may correspond with server system 110 of FIG. 1. Server system 300 may include a core functional module or kernel 310, which may be configured as a module to control overall operation of the system as well as support functionality as described subsequently herein. The core module 310 utilizes functions provided by an operating system 350. A backend system applications module 340 may be coupled to core module 310 to enable user selection of or targeted selection of content for delivery to users. The backend systems applications module 340 may be coupled to databases via a database interface 330. The database interface can be coupled to databases such as the user database 150, the postings database 160 and the categories database 170 of FIG. 1.

Additional interface modules may be included in server system 300, either configured separate or integrated in functionality with other modules. For example, a user may access the system through a user device interface 370, which may be operated in conjunction with a client application executing on a user device and/or a web browser. A display interface module 380 provides data and graphics information to be displayed on a display device of a user device.

The backend system applications module 340 may comprise non-transitory computer-readable storage media, such as memory devices or other storage components to store instructions for execution by computer processors. The instructions may be used to implement the various functions described subsequently herein.

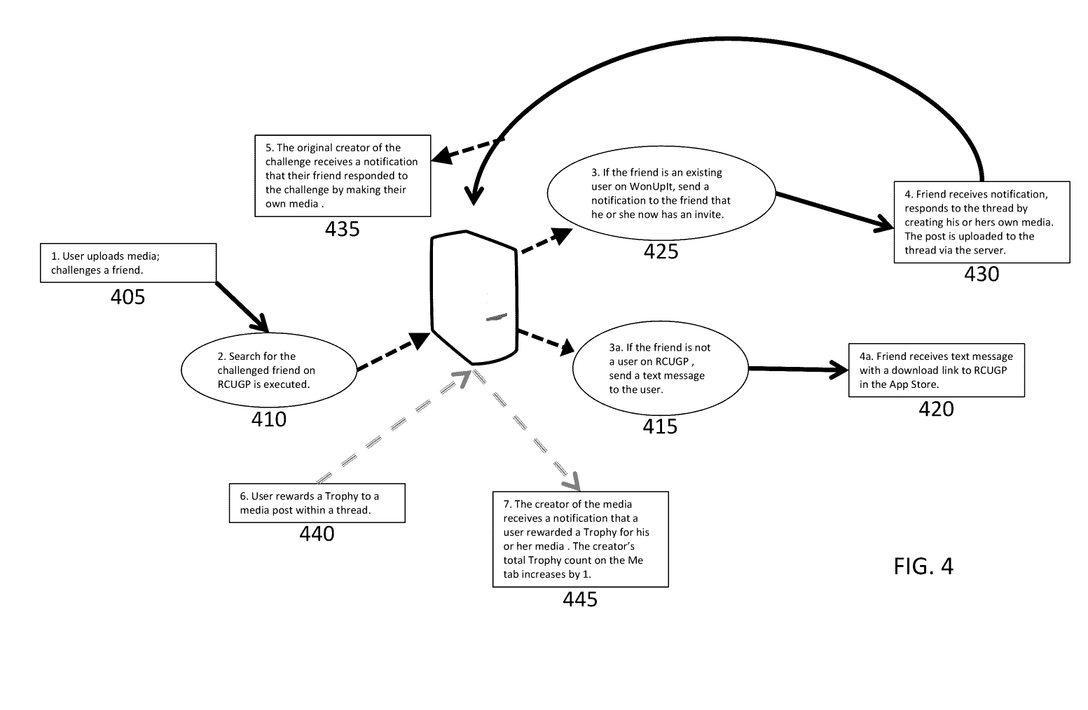

FIG. 4 is a data flow illustrating an exemplary process for using the RCUGP. In some embodiments, a user can upload media to the RCUGP and can challenge a friend to upload better media than the user's original post (stage 405). In some embodiments, the user's challenge creates a category, thread, or the like, to which other users can respond. The category, thread, or the like can be public so that all users of the RCUGP can respond to the user's media, or the user can choose to challenge one or more specific users, such as the user's friends. When the user chooses to challenge a particular friend and/or group of friends, the user can search for the challenged friend in the RCUGP user database (stage 410).

If the friend is not a user of the RCUGP, the RCUGP can generate a message to the friend (stage 415). The message can indicate that the friend has received an invite from the user, and that the friend can create an account on the RCUGP to view the invitation and/or content. In some embodiments, the message sent by the RCUGP is a text message to the user's friend (stage 420). In some embodiments, the RCUGP can access the user's contacts on the user's mobile device or the RCUGP can provide a prompt for the user to enter the friend's information. The RCUGP can also send an email or use the user's other social media accounts, such as Facebook®, SnapChat®, Twitter®, Instagram®, Tumblr®, and/or the like, to generate a message to the user's friend. The message can include a link to download an RCUGP application from a third party, such as the Apple App Store or Google Play. In some embodiments, the message can include a link to a website associated with the RCUGP.

If the friend is a user of the RCUGP, the RCUGP generates and sends a notification, message, and/or the like, to the friend (stage 425). The generated notification, message, and/or the like notifies the friend that (s)he has received an invite from the friend. The notification may be sent to a user's device, such as a text message, SMS, MMS, iMessage, chat, instant message, email, social media message, iPhone Notification, and/or the like. In some embodiments, the notification may also be displayed to the user when the user logs in to the RCUGP. For example, the notification may be displayed on the user's Home Screen, Profile Page, and/or the like. In some embodiments, the notification may be a banner that is displayed on the user's device within the user interface on the RCUGP. The banner may be displayed on all pages while the user browses the RCUGP, and may provide an option for the user to dismiss and/or respond to the notification.

The friend can respond to the user's message by creating and/or uploading his or her own media (stage 430). The friend's media can be uploaded to the thread created by the first user. In some embodiments, the friend's media is uploaded to the thread created by the first user as a default setting when the user is responding to a notification, but in some embodiments, the friend can choose to upload his or her media to a new thread.

When the friend responds to the user's challenge, the server generates a notification and/or message that is sent to the user (stage 435). In some embodiments, the notification and/or message to the original user can include a link to the friend's media, or the notification and/or message can include a link to the thread.

When a user uploads a media to the RCUGP, the user can choose whether to share the media publicly, or to only share the media with a particular user or group of users. In some embodiments, the user can choose to challenge one friend and/or group of friends, while allowing access to the thread to additional users. In such embodiments, the additional users may be able to respond to the thread by adding their own media, while in other embodiments, the additional users may be able to see the thread, but may not be able to respond directly to the thread.

When users view media on the RCUGP, they can award a trophy to their favorite media (stage 440). When a trophy is awarded, the creator of the media receives a notification, message, and/or the like that indicates that (s)he has been awarded a trophy (stage 445). The RCUGP can update the total number of trophies that a user has received every time that a user's media receives a trophy. In some embodiments, a user may be able to award trophies in any thread that the user is able to view, while in other embodiments, a user may only be able to award trophies to a thread in which the user is challenged. In some embodiments, the RCUGP may only allow a user to award a trophy to one post within a thread. The user may be allowed to change his or her selection for the media that should receive the trophy. In other embodiments, the RCUGP can allow a user to award trophies to as many media posts within the thread as he or she wants.

### Account Set Up

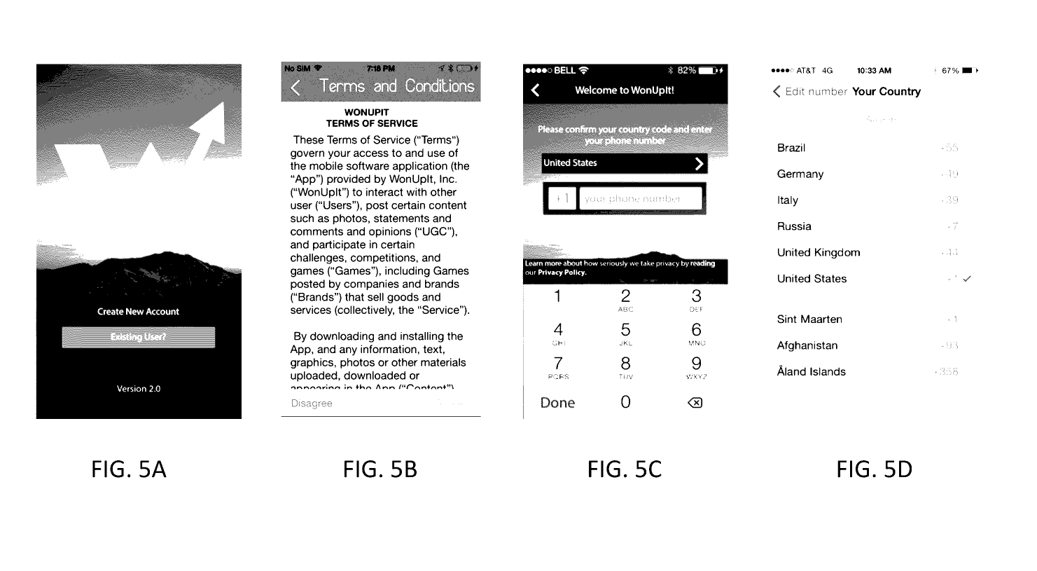

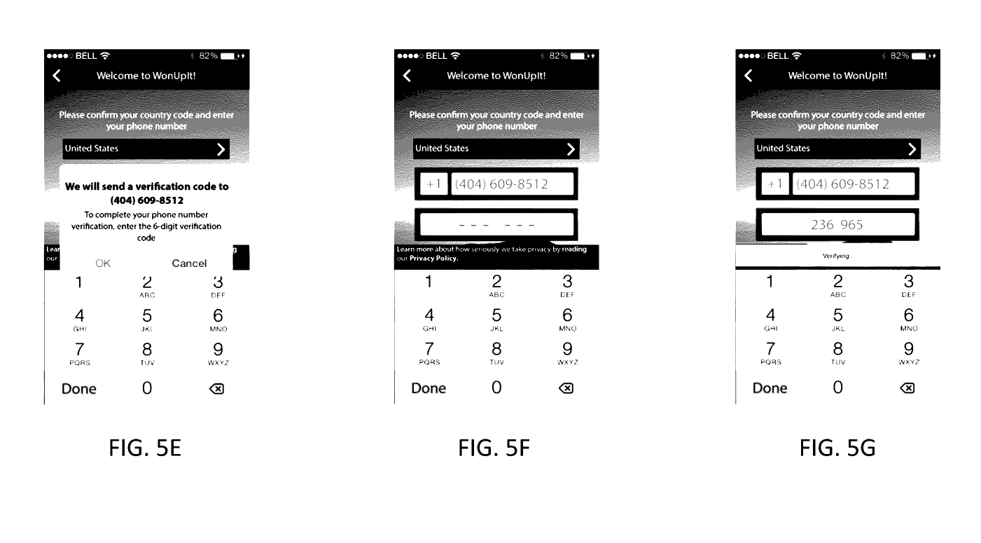

In some embodiments, users may need to log into their account in order to access and/or upload content. FIG. 5A shows an initial log in screen. A user may see this screen the first time they access the RCUGP. This screen may also be displayed when the user has logged out of his or her account on the RCUGP, such as when the user restarts his or her device, when the user installs an update, when the user uses the RCUGP on a new device, and/or the like. The user can be given the option to create a new account, or the user can indicate that they are an existing user. If the user indicates that they are an existing user, a log in screen may be displayed that allows the user to enter his or her username and password and/or email address and password.

If the user indicates that (s)he wants to create a new account, a screen displaying terms and conditions may be displayed, as shown in FIG. 5B. (The terms and conditions shown in FIG. 5B are exemplary only and are subject to change.) In some embodiments, a welcome screen such as that shown in FIG. 5C can be displayed and the user can then be asked to indicate their country and phone number. The country may originally be displayed as the United States. In some embodiments, the United States is the default, while in other embodiments, the RCUGP can detect the user's location, such as by using the GPS on the user's phone and/or other device. In some embodiments, the user can enter his or her phone number, and the RCUGP can determine which country to display based on the entered phone number.

Even if the RCUGP uses these methods to determine the user's location, the user can be given the option to change the country. If the user chooses to do so, the user can tap the displayed country or the arrow next to the displayed country. FIG. 5D shows an exemplary list of countries from which the user can select their country. The user can choose to search their country or can scroll through the list until his or her country is displayed. In some embodiments, the countries are listed in alphabetical order, while in other embodiments, the RCUGP can display a few countries that it determines that the user is likely to be from to display first, and after those countries the remaining list is alphabetical. The list of countries that the user is likely to be from can be determined several ways, including the top countries where the RCUGP is used, the countries with the highest number of recent new users. The RCUGP can also use user-specific criteria to determine the country. For example, the RCUGP might be able to access a user's profile information, such as the information stored in their personal device (such as a mobile phone) and/or social media accounts. Additionally, the RCUGP can use the entered phone number and/or country code entered with the phone number to determine the most likely countries to display for the user. In some embodiments, the RCUGP may also use a GPS signal from the user's device.

Once the user enters his or her phone number, the RCUGP can send a verification code in order to verify the user's account. As shown in FIG. 5E, in some embodiments, the RCUGP can display a pop-up indicating that a verification code is being sent to the user's phone number. The message can also indicate that the user cannot complete verification of the account until this code is entered. This code can be sent via text message, SMS, MMS, iMessage, chat, instant message, email, social media message, and/or the like. In some embodiments, this code can be six-digits, but other implementations allow for a verification with fewer or more characters. The characters can be numbers, letters, symbols, case-specific letters, and/or some combination thereof.

The RCUGP can then display the screen for the user to enter the verification code. One such screen is shown in FIG. 5F. As shown, the RCUGP shows the same country and phone number entry screen of FIG. 5C but also including a line for the verification code. In other implementations, a new screen can be displayed for the verification code. FIG. 5G shows the screen of FIG. 5F with a numeric six-digit verification code entered.

In some embodiments, the user can be asked to enter a username, email address, and/or password. In some implementations, the user's phone number and/or email address can be used as his/her username. In other embodiments, however, the user can choose a username. The username and password can be any combination of numbers, letters, and symbols. In some embodiments, there can be limitations regarding what symbols can be used in the username and/or password.

### Home Screen and Navigation

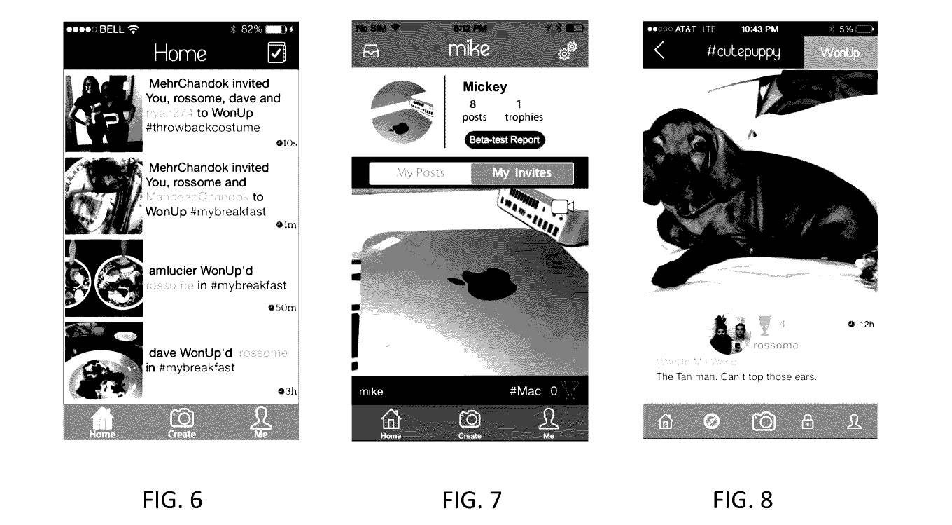

In some embodiments, a home screen can be displayed when the user is logged into his or her account. FIG. 6 shows an embodiment of a home screen. The home screen can have a list of thumbnails of media. In some embodiments, all types of media posts are shown on the home page, while in other embodiments, only one type of media (e.g., photos) are shown on the homepage. Additional information about the media can also be displayed on the home screen, such as the user who posted the media, the categories the user has chosen for the media, the date the media was posted, a number of trophies the media has received, the amount of time that has passed since the media was posted, the day and time the media was posted, users that have been challenged to “WonUp” the media, and/or the like. A trophy icon can also be displayed, such that when the user taps the trophy icon next to particular media, a trophy is awarded to that particular media. A trophy may also be awarded by clicking and/or tapping on the media post, double-clicking and/or double-tapping the media post, and/or the like.

The media can be displayed on the user's home page in reverse chronological order with the most recent media displayed at the top of the home screen and older media displayed below. In other embodiments, the media can be organized based on the number of trophies awarded, and media that receives more trophies can be at the top of the home page. Alternatively, the media can be sorted based on the number of people with whom the media has been shared. For example, a media post shared with the user and only a few other users might be displayed higher on the home page than a media post shared with all users.

In some implementations, clicking and/or tapping a category associated with a media can redirect the user to a page that displays other content or groups of content, such as threads, that use the category. The RCUGP can perform a search to find the content or threads with the category. In some embodiments, threads using the category can be displayed based on the number of trophies awarded within the thread, or, in other embodiments, can be displayed based on the number of trophies awarded to the leader (i.e., the post with the most trophies) in that category. In other implementations, the threads and/or content can be displayed in reverse chronological order, such that the newest posts marked with that category are displayed first. In yet another embodiment, the original media can be displayed at the top of the page, and the responses can appear below the original media.

Clicking and/or tapping a username associated with media can redirect the user to the profile associated with the username. The user's profile can display the username, the user's name, the user's profile photo, the user's location, thumbnails of the user's media posts, full versions of the user's media posts, number of trophies awarded, categories to which the user has posted, categories to which the user most frequently posts, and/or the like. When a user views his or her own profile page, the display can include the user's name, username, number of posts, numbers of trophies awarded, a user's profile photo, and/or the like. An example embodiment of the user's own profile page is shown in FIG. 7. In some embodiments, the user's most recent posts can appear, for example in reverse chronological order such that the user's most recent post is displayed first. The category to which the user posted the most recent post can also be displayed, as well as the number of trophies that post has received. In some embodiments, the user can also have the option to view invites received from other users.

From either the home page and/or the profile page, a user may be able to click on a thumbnail to view post details. An exemplary screen shot of a post details screen is shown in FIG. 8. In some embodiments, the post details page can display the media in a larger size. When viewing the media in the larger size, the user who posted the media, the categories the user has chosen for the media, the date the media was posted, a number of trophies the media has received, the amount of time that has passed since the media was posted, the day and/or time the media was posted, and/or the like. Additionally, in some embodiments, comments made by other users can also be displayed. The user can also be given the option to input a comment on the media. The user may also be given the option to “WonUp” the media by posting their own media.

### Post Creation

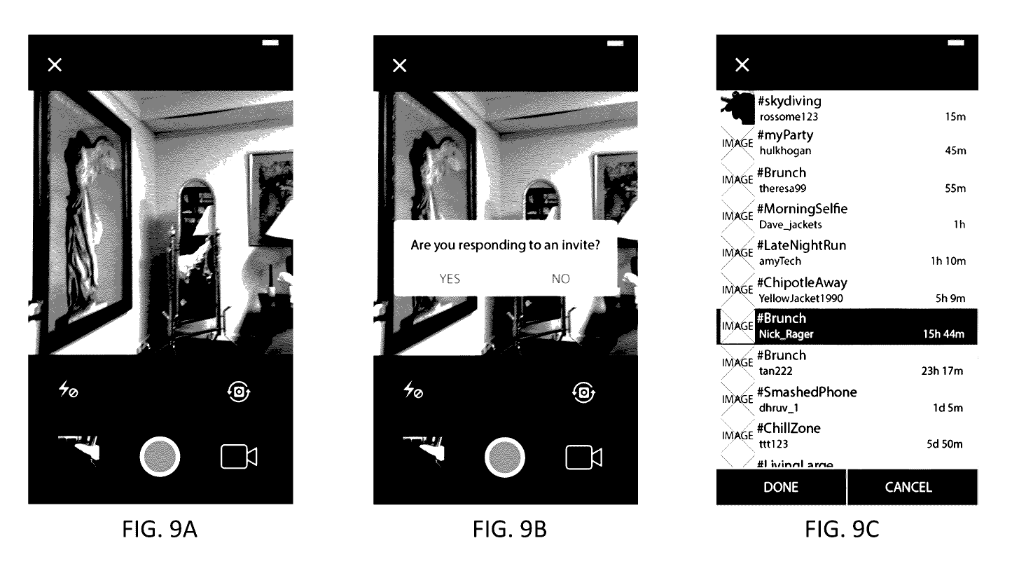

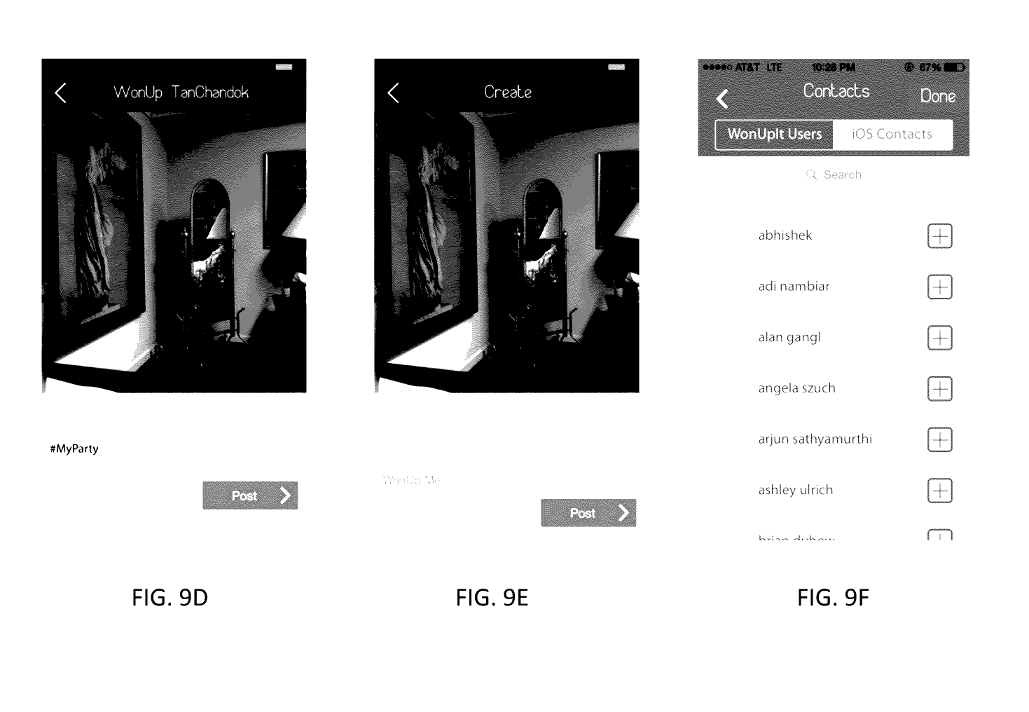

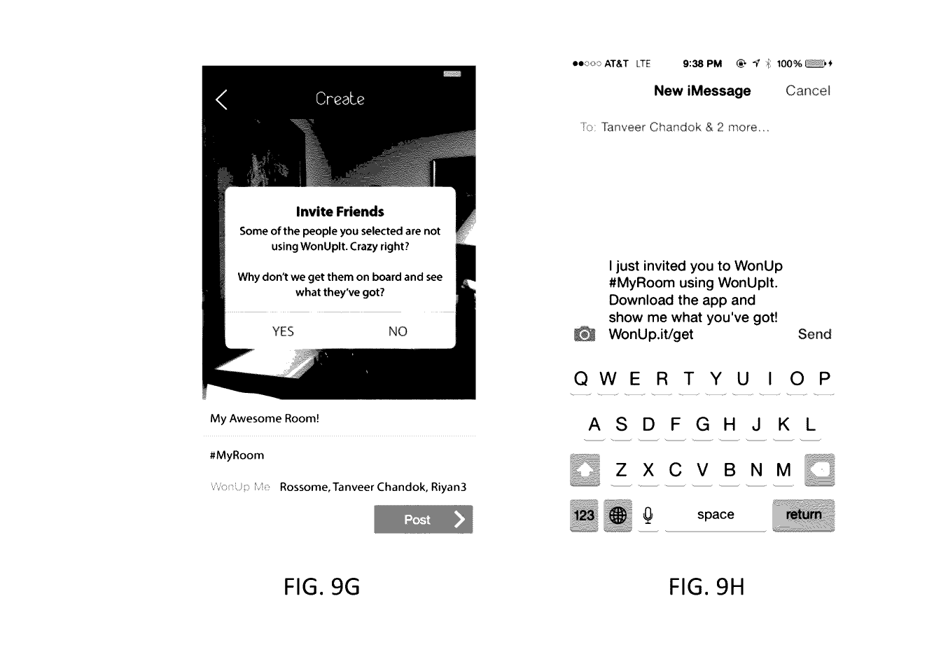

Users can upload media to the RCUGP. For example, a user may upload media when (s)he wants to post their own original media and/or when (s)he wants to “WonUp” a media post that is already on the RCUGP. In some embodiments, users are given the option to choose from media that has already been taken (e.g., photos that have already been taken) or to open the camera (or other receiver, such as the microphone) on a user device to take a photo, video, and/or other media. If the user selects to choose from media that (s)he has already taken, the RCUGP accesses the media on a user device and allows the user to click and/or tap media from the list. If the latter option is selected, the RCUGP can access the camera (or other receiver) on a user device and allow a user to take a photo, video, and/or other media, as shown in FIG. 9A. Once the user has selected or taken the media that (s)he wants to upload, the RCUGP can display a message asking if the media is original media post or if it is a response to media posted by another user (as discussed further below, in “Challenges”). For example, in FIG. 9B, the user is asked “Are you responding to an invite?” and the user can click or tap “yes” or “no.”

If the user is responding to media posted by another user, the RCUGP can display a list of the user's invites to select, as shown in FIG. 9C. The user can select the invite to which (s)he is responding, such as by clicking or tapping the invite. In some embodiments, the invites are listed by displaying the category and/or the username of the other user who sent the user the invite. In some embodiments, the RCUGP displays the invites based on the time elapsed from the time the invite was sent, such that the most recent invite is at the top of the list.

In some embodiments, the RCUGP can use image processing and image recognition to determine potential categories for the image, and the RCUGP can determine which invite categories are the most likely to be relevant to the user's image, and display the invites based on relevance. In some embodiments, the RCUGP can detect what type of media the user has uploaded (e.g., photo, video, voice recording, and/or the like), and can determine which categories are more likely to be suited for that particular type of media, and discern relevance of the categories based on this determination. For example, the RCUGP may detect that the uploaded media is a photo, and therefore can determine which categories are more likely to be suited for a photo as compared to a video, audio, and/or other type of media upload, and the relevance of the categories may be discerned based on the determination. The RCUGP can then sort the invites based on detected relevance. In some embodiments, the RCUGP can determine the relevance of certain categories to a media post, but can also provide an option to the user to display the posts in chronological order.

Once a user selects which invite (s)he is responding to from the list of invites, the RCUGP displays a posting screen, such as that shown in FIG. 9D. In some embodiments, the posting screen can include the user's username and the media that the user has uploaded. In some embodiments, because the user is responding to an invite, the RCUGP can auto-populate the category. In some embodiments, even though the user is responding to an invite in a particular category, the user can change the category to which (s)he is posting the media. The user may also add and/or remove categories. The user can add his or her own caption to the media. In some embodiments, the posting screen can also show which user the media is attempting to “WonUp.” The posting screen may also provide the option for the user to challenge additional users to “WonUp” his or her media.

If the user is posting original content that is not in response to an invite, the RCUGP can display the posting screen, such as the posting screen shown in FIG. 9E. The user can insert his or her own caption and/or category. In some embodiments, the user can also select the audience for the media. For example, the user can choose to share with everyone who uses the RCUGP. The user can also be given the option to share with all of his or her connections on the RCUGP, or can choose to specify which connections to share the media. The user can also choose to keep the media private without sharing the media with anyone. The private media may be available on the user's own profile (discussed below in “User Profile”) and would not be shared with any other users of the RCUGP. The user can also select a few friends and/or users with whom the user wants to share the media. For example, the user can select friends within the RCUGP by name, username, phone number, email address, and/or the like. In some embodiments, the RCUGP can have access to the user's contacts and/or social media accounts, and the user can select friends from the contacts and/or social media accounts with whom the user wants to share the media. If the friends selected are users of the RCUGP, the RCUGP determines the friends' usernames and sends the invite to them. If the friends are not users of the RCUGP or if the RCUGP does not have sufficient information to determine a friend's username on the RCUGP, the RCUGP can send a message, such as a text message, SMS, MMS, iMessage, email, social media message, and/or the like, to invite the friend to join the RCUGP. The RCUGP can suggest a method for sending the message to the friend by using the contact information stored in the user's contact list.

In some embodiments, the RCUGP can display a list of contacts from which the user can select friends with whom the user wants to share the media, as shown in FIG. 9F. In some embodiments, this screen is automatically displayed when the user clicks or taps a “choose friends” field, such as the one displayed in FIG. 9E. In some embodiments, the user can type in the “choose friends” field and the RCUGP can provide suggestions based on the information entered by the user. In some embodiments, the user can view a list of RCUGP users, a list of friends within RCUGP, a list of the user's contacts (such as contacts stored in a user's phone), a list of contacts from social media accounts (such as Facebook® friends, Twitter® followers, LinkedIn® connections, SnapChat® friends, Instagram® followers, Tumblr® followers), and/or the like.

Once the user selects the contacts with whom the user wants to share the media, the user can indicate that (s)he is done selecting friends. If not all friends are users of the RCUGP, the RCUGP can display a pop-up message to notify the user that not everyone has an account on the RCUGP. An example embodiment is shown in FIG. 9G. The user is given the option to send friends who are not on the RCUGP an invitation to join RCUGP. If the user chooses to invite these friends, the RCUGP can automatically generate a message, such as a text message, for the user to send to the non-users. A sample embodiment is shown in FIG. 9H. If the user does not want to invite the friends who are not users of the RCUGP to join, the RCUGP proceeds to post the media, but the media is only shared with friends who have RCUGP accounts. Friends with RCUGP accounts with whom the media is shared will see the post on their home screens, and a notification is sent to them to indicate that they have been challenged.

In some embodiments, a user can also be given the option to post the media to external social media sites, such as Facebook®, Twitter®, LinkedIn®, SnapChat®, and/or the like. If a user selects this option, the RCUGP can push the media to those sites. In some embodiments, the RCUGP can prompt the user to enter usernames and/or passwords for those social media sites. In some embodiments, usernames and/or password for those social media accounts can be entered by the user and stored in the RCUGP, such that when the user selects this option, the RCUGP can find the information and use that information to log into the user's account in order to push the media to the social media site without requiring the user to enter another username and/or password.

### Challenges

As discussed above, in some embodiments, the user can choose other users with whom (s)he would like to share their media. Users can also select other users that they would like to challenge to WonUp their media post. The user can choose to challenge certain other users and/or challenge “the world,” i.e., all users. In some embodiments, the user can set a preference for all media, wherein the preference becomes a default setting for all of that user's posts. Whether or not the user sets his/her preference, the user can change the share and/or challenge settings for each media post.

The users with whom the media is shared, including all users of the RCUGP if the media is shared with “the world,” can be given the option to WonUp the media. In some embodiments, the users can click or tap a WonUp button, which can then display a screen that allows the user to upload media that they believe “WonUps” the original media post. This can be substantially similar to the “Posting Screen” discussed above.

The RCUGP may provide default categories, which can be the same categories as the original media post. In some embodiments, the RCUGP can also automatically populate the group with whom the media will be shared. The auto-population of the share group can be the same group with whom the original post was shared. In some embodiments, the user may be able to change these share settings for their response post. For example, if the original media post is shared with the world, the user may be able to share a response media post only with a select group, such as the user's connections on the RCUGP. The user can also be given the option to add his or her own caption to the media.

### User Profile

If the user taps his or her own profile name, and/or if the user clicks a home screen icon, the RCUGP can display the user's own profile page, as shown in FIG. 7. In some embodiments, the user's own profile page can be viewable only by the user him or herself. In other embodiments, other users of the RCUGP may view the user's profile page. The user's profile page can display various pieces of information about the user. For example, the profile can display the username, the user's name, the user's location, thumbnails of the user's media uploads, full versions of the user's media uploads, number of trophies awarded, and/or the like. The user's profile page can also display the number of posts the user has made, a total number of users that the user is following, and/or a total number of users that are following the user. From the profile page, the user may be able to edit, update, and/or delete any of the displayed information. In some embodiments, the default screen shown for the user's own profile can be the user's media uploads.

In some embodiments, the user's profile page may also include a profile picture, profile video, and/or other identifying media (hereinafter “profile picture” or “profile photo”). The profile picture can be uploaded to the RCUGP specifically to be the user's profile photo, or it can be media that the user uploads to the RCUGP. The user's profile photo can also be pulled from the user's Facebook® profile, Instagram® profile, Twitter® profile, and/or the like. For example, when a photo from Facebook® is used for the user's RCUGP profile photo, the Facebook SDK may be used to pull the content.

The user's own profile page can also show a notifications link. For example, the icon can be a mailbox or an envelope, and by clicking the icon, the user can view messages. Messages can be sent between users, and can occur between two individual users. Messages can also be group messages that contain multiple users. A user can initiate a message by clicking on a button that is displayed on their own profile page and can type the name of users to whom they would like to send a message. A user may also be able to initiate a chat with another user from the other user's profile page, such as by clicking a messages button and/or icon displayed on the other user's page.

The user's own profile page can also contain a list of invites. In some implementations, the user can send connection invitations to other users of the RCUGP. Similarly, the user can be invited by other users to connect. When the user receives an invitation to connect to another user, these invitations can be shown in a list of invites, such as a “My Invites” page. Additionally, users can send invitations to WonUp media that (s)he has uploaded. These invitations can also be displayed in the “My Invites” page. In some embodiments, the invitations to connect and invitations to WonUp can be displayed in the same screen. In other embodiments, the invitations to connect and invitations to WonUp can be displayed on separate pages. The invitations can be displayed in reverse chronological order, such that the newest invitations are displayed on the top of the screen.

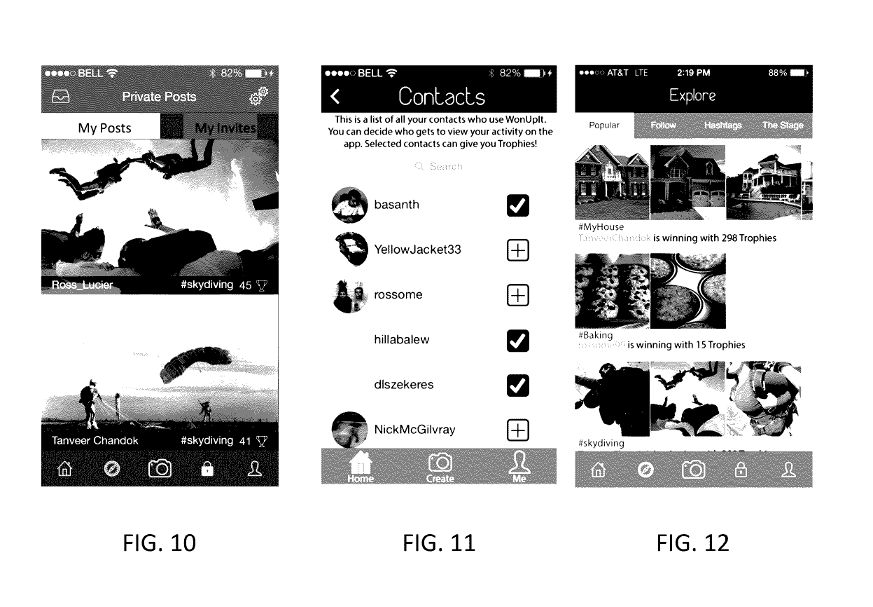

In some implementations, both the user's own profile page, the notification page, and the invitation pages can be a part of a private feed that is only viewable by the user. Each user thus has his or her own unique, private feed that only (s)he can see, and this content can be encrypted. In some embodiments, users can share private media that only the user can see, as shown in FIG. 10. For example, a user can upload media that the user does not want to share.

### Contacts

In some embodiments, the RCUGP can import contacts from a user device. The RCUGP may also be able to import contacts from other social media websites, such as Facebook®, Instagram®, Twitter®, Snapchat®, Tumblr®, LinkedIn®, and/or the like. When using Facebook®, for example, the Facebook SDK may be used to retrieve the data. The RCUGP can determine, based on information in the contacts list and an RCUGP database, whether the user's contacts are members of the RCUGP. The RCUGP can use this list to suggest potential connections for the user.

Additionally, the user may be able to access a contacts page. A sample contacts page is shown in FIG. 11. In some implementations, there may be a link to the user's contacts from the home page, which is discussed above. The contact list in the RCUGP can display the user's connections in the RCUGP, as well as contacts that are not connections in the RCUGP. In some embodiments, the user may be able to invite contacts to join the RCUGP from this contact list, such as by clicking or tapping the contact's name. For contacts that are users of the RCUGP and with whom the user is connected, a check box can be displayed next to the connection's name in the contact list. For contacts that are users of the RCUGP and with whom the user is not connected, a ‘connect’ or plus (‘+’) icon can be displayed next to the contact's name, and if the user clicks or taps the icon, a connection request can be sent to the user. If the other user accepts the connection request, the users will become connections on the RCUGP.

In some embodiments, users may be able to follow other users without becoming connections. The RCUGP can notify the other user that they are being followed by the user, but may not require acceptance from the other user. In this embodiment, the other user's posts will be displayed on the user's home page, but the user's posts will not be displayed on the other user's home page.

### Explore

A user may be able to view an explore screen, shown in FIG. 12, that allows the user to view additional posts from outside the user's connections on the RCUGP. The explore screen can have several sub-tabs. In some embodiments, the sub-tabs can include popular, follow, hashtags, and the stage. In order to comply with users' privacy preferences, only threads shared with “the world” will be displayed in the explore screens. In other implementations, the posts that have been shared with a particular user can be shown in that particular user's explore screens.

### Popular

In some embodiments, the popular tab can display the top threads posted by all users. In some embodiments, the top threads are determined by the overall number of trophies awarded in the thread. In other embodiments, the top threads may be determined by the most trophies awarded to a single media post in the thread. This can be the top number of trophies awarded all-time, or can be the highest number of trophies awarded over a certain period of time, such as 24 hours, a week, a month, a year, and/or the like. In some implementations, the top 100 threads can be displayed.

In order to determine the top threads, the RCUGP can search all threads that have at least two media posts uploaded. The RCUGP can sort the media within the threads and sort the media from highest to lowest priority. In some embodiments, media with the highest priority are the media posts that have received the highest number of trophies, while the lower priority media posts are those that have received the fewest trophies. The threads can then be sorted by those with the highest trophy count from a single user within the thread. In some embodiments, the threads are sorted such that a first thread with a single media post that has received the most trophies is ranked higher than a second thread with more overall trophies, but where the media with the most trophies in the second thread has fewer trophies than the single media post with the most trophies from the first thread.

In some embodiments, the popular tab of the RCUGP displays the top few threads, after which the remaining threads within the top threads are randomized. For example, the RCUGP can display the top ten threads, and display the remaining ninety threads from the top 100 in a random order.

Within the popular tab, for each thread, the RCUGP can display the category and the username of the user whose media has the highest number of trophies. The username of the user who started the thread may also be shown. The RCUGP can also display the number of trophies the top media has received. In some embodiments, the RCUGP also shows the number of trophies by which the top media is beating the media with the second-most trophies within the thread.

### Follow

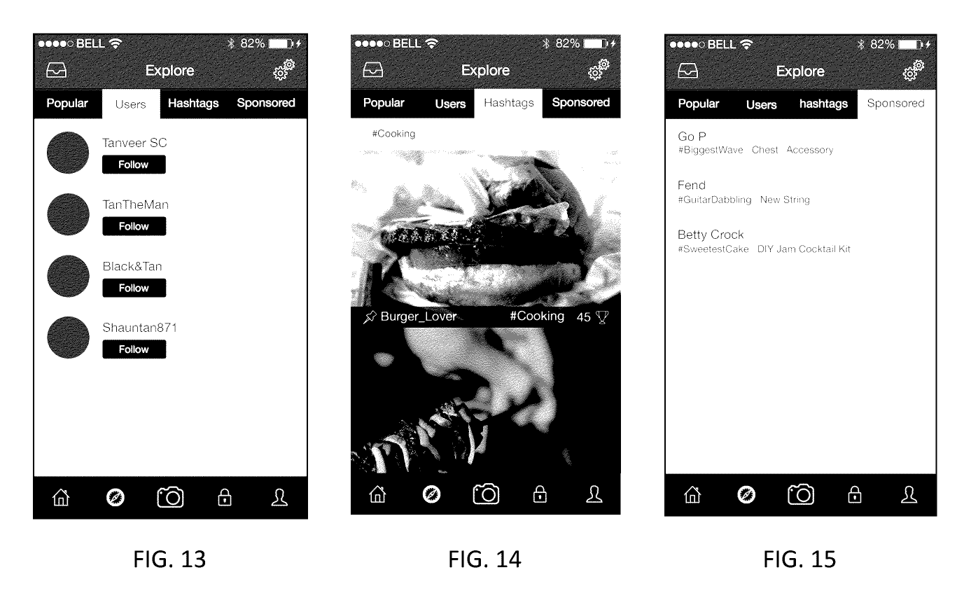

The Follow tab of the Explore page can display a list of users that the RCUGP suggests that the user should follow. In one implementation, this tab can be labeled “Users,” as shown in FIG. 13. In some embodiments, this can be populated from the user's contact list from the user device and/or from the user's other social media accounts. In other implementations, the RCUGP can determine various metrics and use those metrics to suggest other users for the user to follow. For example, the RCUGP may be able to determine that the user frequently looks at threads and/or media posts that have categories related to skiing. The RCUGP can suggest that the user follow other users that are also interested in skiing, or those who post a significant number of media posts marked with skiing-related categories.

In some embodiments, the list of suggestions may be sorted based on the number of trophies users have received (i.e., such that users who have the most trophies are at the top of the list of suggestions), common interests between the users, and/or the likelihood that the user knows the suggested users.

### Hashtag

In some embodiments, the categories with which users mark their media posts can be in the form of a hashtag. For example, media that the user wants to mark as being in the skiing category can be marked “#skiing,” and the RCUGP will categorize the media as being in the skiing category.

Selecting the hashtag tab of the explore page can allow a user to search for posts using the categories, or hashtags. A sample embodiment is shown in FIG. 14, where the user searched “#Cooking” and posts using the category “#Cooking” are displayed. In another example, the user can type “skiing” and the RCUGP will display all threads marked with “#skiing.” In some embodiments, the RCUGP can learn that certain categories are interrelated. The RCUGP can then also suggest other categories that the user might be interested in based on his or her previous searches. For example, the RCUGP can determine that many users who view the #skiing category have also viewed the #snowboarding category, and when a user searches for skiing, the RCUGP can also suggest posts in the snowboarding category.

When a user displays posts based on the category, posts may be displayed in order based on the number of trophies that were awarded to each media post. Thus, the post with the most trophies may be displayed first, and the remaining posts are displayed in in descending order based on the number of trophies. In other embodiments, the posts may be displayed chronologically, such that the originating post is displayed at the top and subsequent posts are displayed in chronological order, or in reverse chronological order, where the most recent posts are displayed first and the originating post is at the bottom.

### The Stage

Companies who use the RCUGP can have their own profile. In this regard, The Stage tab can provide messages from sponsoring companies, including sponsored challenges by a particular company. For example, a sponsoring company may want to challenge users to WonUp the world using a particular category, or hashtag. A sponsoring company has the ability to set the rules for their challenge. Using the example above, a ski resort might issue a challenge to post the best picture from their slopes on a particular day or for a particular season. A RCUGP user can then upload a picture and/or video under the sponsored category in hopes of gaining the most trophies.

In some embodiments, the sponsoring company can provide an award to the user who gets the most trophies and/or to any user who gets over a certain threshold of trophies, such as anyone who earns over 5,000 trophies. These challenges can have expiration dates, as set by the sponsoring company. The sponsoring company can also use the challenges to find and reward loyal users. Further, the sponsoring companies may also place restrictions on content that is eligible for the challenge. For example, a company can make it mandatory to use a particular product or line of products in the post in order to be eligible for the contest.

A sponsoring company may receive information about users who respond to their sponsored category. For example, the sponsoring company may receive one or more of the following: the user's age, location, username, full name, phone number, products used in the post, and the number of trophies. In some embodiments, users may be able to set privacy controls that determine what information they are willing to share with the sponsoring company, but in other embodiments, by participating in the sponsored category, the user agrees to share this information with the sponsoring company. Information on the products that were used in the post maybe determined based on user input, such as a caption field where a user can input information on the products used and/or a SKU/QR code scanner. The RCUGP may also scan a post to find SKU and/or QR codes, or may use image recognition to determine the products that are in the post.

In some embodiments, a sponsoring company may be able to input product advertising for various products. For example, the sponsoring company may have market research that indicates that users who post media that have product A may be interested in product B. The RCUGP may then provide targeted advertisements to the user for Product B based on the fact that the user posted media containing Product A.

For example, an athletic company “Company A” may create a sponsored hashtag “#CompanyARun.” A user (“User B”) posts media with the category “#CompanyARun” and receives 100 trophies. Company A notices that User B's media shows User B is using last year's model sneakers, so Company A sends User B an offer to receive a discount on the new model sneakers.

As another example, Company C, another athletic company, creates a sponsored hashtag “#CompanyCRuns.” Company C indicates that whoever gets the most trophies by a specified date will receive a free pair of sneakers. User D receives the most trophies, and therefore User D wins the challenge. Company C sends User D a new pair of sneakers (or a voucher for User D to pick out their new pair of Company C shoes).

Companies may also reward all users who share images with a sponsored category. For example, Company E is a small restaurant that wants to advertise their lunch specials. Company E creates a sponsored hashtag “CompanyELunch,” and all users who post media that shows their meal and includes the sponsored hashtag receive a discount on their next meal.

In some implementations, the RCUGP may collect data for sponsoring companies that helps the sponsoring company determine user interests. For example, the RCUGP may determine that a large number of users who have posted media containing Product A also have Product C. This information may be provided to sponsoring companies that are related, in some way, to Product C. Users of the RCUGP may be able to opt in and/or opt out of these features.

In some embodiments, The Stage tab may be alternatively labeled “Sponsored,” as shown in FIG. 15.

### Exemplary Notifications

Table 1 includes an exemplary set of notifications that can be displayed on a user's device based on various events on the RCUGP. For example, these notifications may be displayed within the RCUGP by the client application 122 or Web browser 140. Alternatively, messages including the notifications can be sent to a user device and displayed by other applications (e.g., by an electronic mail or text application).

TABLE I

| Num | If this happens | EXAMPLES |
|---|---|---|
| 1 | I create a new photo or video and WonUp my friends | You invited rossome, riyan123 and mandy to WonUp #sunset |
| 2 | I create a new photo or video and WonUp the World | You invited the World to WonUp #coffee |
| 3 | I respond to a photo or video someone sent me | You WonUp'd john_haden in #running |
| 4 | I respond to a World photo or video | You WonUp'd the World in #drinkthis |
| 5 | I respond to a message on The Stage (sponsored photo or video) | You WonUp'd the World on The Stage in #GivesYouWings! |
| 6 | User I follow creates a photo or video (friends) with me NOT | Bosanth123 invited rossome, Varma and John21 to WonUp #MyPint |
| | invited to the challenge | |
| 7 | User I follow creates a photo or video (friends) with me invtited to | Bosanth123 invited you to WonUp #MyPint (OR) Bosanth123 invited |
| | the challenge | you, riyan24, greg1 and rossboss to WonUp #MyPint (OR) Bosanth123 |
| | | invited you and mandy66 to WonUp #MyPint |
| 8 | User I follow creates a photo or video (world) | bigman12 invited the World to WonUp #livinglarge |
| 9 | User I follow responds to a photo or video - Friends | tunnysC WonUp'd herms21 in #skiing |
| 10 | User I follow responds to a photo or video - World | hunter41 WonUp'd the World in #BigDeer |
| 11 | User I follow responds to a message on The Stage | DavidLi WonUp'd the World on The Stage in #travelling! |
| 12 | One of my photos or videos gets 5/25/50/100 comments | 50 people commented on your #MyBeer post! |
| 13 | One of my photos or videos gets | 250 people gave you a Trophy for your #cool post! |
| | 5/10/20/50/100/250/500/1K/10K/100K Trophies | |
| 14 | User I follow photo or video gets 5/25/50/100 comments | 100 people commented on #surfsUP by Dave_Kear! |
| 15 | User I follow photo or video gets | 1K people gave Felicia99 a Trophy for #Fitness! |
| | 5/10/20/50/100/250/500/1K/10K/100K Trophies | |
| 16 | If there are more than 5 responses to a particular photo or video - | Your WonUp to #Guns just reached the Number 3 spot! |
| | AND one of my photos or videos is the 1^{st}/2^{nd}/3^{rd} highest in terms | |
| | of Trophy count | |
| 17 | If there are more than 5 responses to a particular photo and video - | #Shooting by Renee332's just reached the Number 1 spot! |
| | AND one of my FRIENDS photos or video reaches the 1^{st}/2^{nd}/3^{rd} | |
| | highest in terms of Trophy count | |

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded into one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for facilitating media-based challenges, the method comprising:
receiving, at a server, an initial media upload associated with an account of a challenger and information identifying at least one challenged user, the initial media upload being provided by a client application executing on a user device of the challenger;
searching a database of users to determine if there exists an account corresponding to the at least one challenged user;
generating, at the server, a challenge notification for the account corresponding to the at least one challenged user;
receiving, at the server and in response to the challenge notification, a response media upload associated with the account corresponding to the at least one challenged user; and
generating, at the server, a response notification for the account of the challenger and providing the response notification to the client application.

2. The method of claim 1, further including;
determining that there does not exist an account corresponding to the at least one challenged user;
providing, to the account of the challenger, an indication that the at least one challenged user does not have an account;
receiving an indicator that the challenger desires to send an invitation the at least one challenged user; and
generating a message used in sending the invitation to the at least one challenged user.

3. The method of claim 1 further including receiving, at the server, an audience target audience wherein the audience target includes information identifying an audience with whom the challenger intends to share the initial media upload.

4. The method of claim 3, wherein the audience target comprises at least one of: all users, a single challenged user, and a group of users selected by the challenger.

5. The method of claim 3, wherein the response media upload is shared with the audience target associated with the initial media upload.

6. The method of claim 3, wherein the response indicator further comprises a challenger audience target, the challenger audience target including an audience with whom the at least one challenged user shares the response media upload.

7. The method of claim 6, wherein the challenger audience target is different from the audience target associated with the initial media upload.

8. The method of claim 1, wherein the initial media upload and the response media upload are shared with all users.

9. The method of claim 1, wherein a plurality of other users may award a trophy to one of the media upload and the response media upload.

10. The method of claim 1, wherein the media upload is associated with a category, and the response media upload is automatically associated with the category.

11. The method of claim 1, further including:
receiving, at the server, additional response media uploads associated with accounts corresponding to other challenged users;
associating, by forming a thread, each of the additional response media uploads with the initial media upload; and
receiving trophy indicators from a plurality of other users, wherein each of the trophy indicators is associated with one of: the initial media upload, the response media upload, and the additional response media uploads.

12. The method of claim 11 further including providing commands to display the initial media upload, the response media upload, and each of the additional response media uploads in an order based on an associated number of received trophy indicators.

13. The method of claim 11 further providing commands to display, in a first position, a one of the initial media upload, the response media upload, and each of the additional response media uploads having a largest number of received trophy indicators.

14. The method of claim 11 further including providing commands to display the initial media upload, the response media upload, and each of the additional response media uploads displayed in one of: chronological order and reverse chronological order.

15. The method of claim 1, further comprising:
processing, via an image processing component, the initial media upload to determine at least one suggested category for the initial media upload;
providing, to the client application, an indication of one or more suggested categories;
receiving, from the client application, an indication of a selected category, wherein the selected category is included within the one or more suggested categories; and
associating the initial media upload with the selected category.

16. The method of claim 1 further including receiving, at the server and from the client application, user-provided category information associated with the initial media upload.

17. A processor-implemented method, comprising:
receiving, at a server, information identifying a sponsored category associated with a sponsoring company;
generating a thread associated with the sponsored category and the sponsoring company;
receiving, at the server, at least one media upload from at least one user, wherein the at least one media upload is associated with the sponsored category and is provided by a client application executing on a user device; and
causing display of the at least one media upload within the thread.

18. The method of claim 17, further comprising:
receiving, at the server, other media uploads from other users wherein each of the other media uploads is associated with the sponsored category;
receiving a plurality of trophy indicators, each of the plurality of trophy indicators being associated with one of the at least one media upload and the other media uploads; and
sorting the at least one media upload and the other media uploads based on associated numbers of the plurality of trophy indicators of trophy indicators.

19. The method of claim 17, further comprising:
receiving at least one award metric from the sponsoring company; and
identifying, based on the at least one award metric, one or more of the at least one media upload and the other media uploads.

20. The method of claim 19, further comprising:
receiving a plurality of trophy indicators, each of the plurality of trophy indicators being associated with one of the at least one media upload and the other media uploads;
wherein the identifying includes identifying at least one of:
a one of the at least one media upload and the other media uploads that has received the most trophy indicators,
ones of the at least one media upload and the other media uploads with at least a predetermined number of trophy indicators, and
all media uploads associated with the sponsored category wherein the all media uploads include the at least one media upload and the other media uploads.
